(19) United States
(12) Patent Application Publication
(10) Pub. No.: US 2012/0072561 A1
(43) Pub. Date: Mar. 22, 2012

(54) VIDEO GAME SYSTEM AND METHOD

(76) Inventor: David Stanley Rebacz, Medinah, IL (US)

(21) Appl. No.: 12/884,178

(22) Filed: Sep. 17, 2010

(51) Int. Cl. G06F 15/173

(52) U.S. Cl. 709/223

(57) ABSTRACT

A system and method is provided wherein interactivity between several cellular devices and a server is provided for controlling games and other applications in a physical locale. The applications make use of the cellular device's display and input capabilities to send and receive private data. The server wirelessly communicates with the cellular devices at the locale. The server at the locale gathers input from cellular device users and outputs public information to the locale via display(s), speakers, and other output devices. The server may also interact with other servers existing at other locales by communicating over the Internet.

This application claims benefits of U.S. Provisional Patent Application Serial No. 61/243,148 filed on September 16, 2009.

### CROSS-REFERENCE TO RELATED APPLICATIONS

This non-provisional patent application hereby incorporates by reference U.S. Patent Publication Numbers: 2007/0249422 to Podoloff and 2007/0260984 to Marks et al. These publications are attached hereto as Appendix A and form a part of this disclosure.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### BACKGROUND OF THE INVENTION

Cellular phones and PDA devices have come a long way. Along with them have come games and other interactive applications. Users can play games and run all sorts of applications from the palm of their hand. The devices have their own displays, can be taken virtually anywhere and have access to the Internet. The games have come a long way from being able to play “Brickbreaker” on your Nokia. Most of today's popular games connect users with other users miles away through the Internet.

Entertainment systems have evolved from having wired controller with a few buttons to wireless devices with additional motion sensing and infrared technology. However, these entertainments systems are only suited for one to four people. Furthermore, the controllers have become expensive as they have incorporated new technology.

As entertainment hardware evolved, the gaming possibilities have expanded. However, there are still difficulties in realizing some types of games. For example, Scrabble can be played as a board game but not as a video game because there is no way to keep private information from other users. Similarly, poker and most card games require users to have exclusive information in order for the game to work.

### BRIEF SUMMARY OF THE INVENTION

The present invention relates to a video game system and method, and in particular to a system and method wherein a cellular device application interacts with a router/server, and or Internet, allowing the user access to a specific local area network of their choice.

An entertainment system in accordance with the principles of the present invention would allow a larger number of users to interact together in a convenient way because of the ubiquity of cellular devices. Additionally, private game or application information can be hidden from other users in the locale by using the users' cellular device displays. Public information can be output and displayed to conventional devices in the locale. Thus, a wide range of games and applications that previously could not be implemented are now possible.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a simplified block diagram of a video game system in accordance with the present invention. Reference numbers used within FIG. 1 correspond to the following elements:

| Reference Number | Element |
|---|---|
| 10 | Video Game System and Method |
| 11 | Display of Cellular Device |
| 12 | Cellular Device(s) |
| 14 | Bi-Directional Communication Link(s) |
| 16 | Wireless Access Point or Interface |
| 18 | Router and/or Server |
| 20 | Output Device(s) |
| 22 | Internet |
| 24 | Remote Server(s) |

### DETAILED DESCRIPTION OF THE INVENTION

The following descriptions of detailed embodiments are for exemplifying the principles and advantages of the inventions. They are not to be taken in any way as limitations on the scope of the inventions.

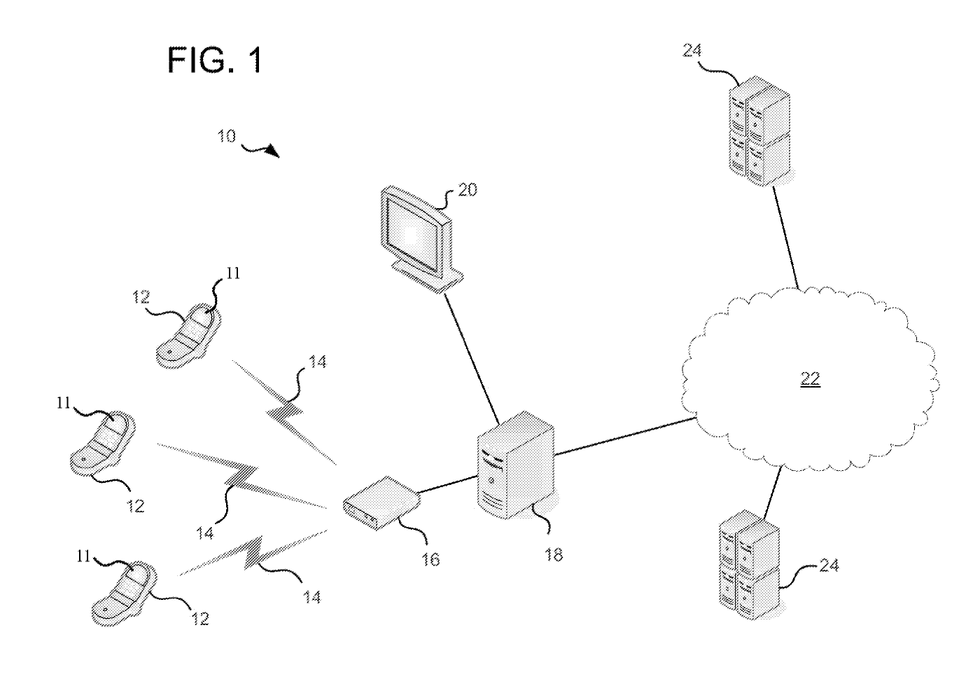

In an embodiment in accordance with the present invention, there is shown a video game system 10 (FIG. 1). The system 10 includes a router 18 that can also operate as a server, if desired. Operatively connected to the router is a wireless access point 16 that bidirectionally communicates wirelessly with one or more conventional cellular devices 12.

Preferably, but not necessarily, the bi-directional wireless communication link(s) 14 between the wireless access point 16 and the cellular device 12 is in accordance with the BLUETOOTH wireless standard (i.e., IEEE 802.15.1). Alternatively, the wireless communication link(s) can be in accordance with other wireless standards such as, but not limited to, the WI-FI wireless standard (i.e., IEEE 802.11).

In FIG. 1, one or more cellular device(s) 12 are conventional electronic devices for placing and receiving telephone calls over a conventional cellular telephone network. Alternatively, one or more of the cellular device(s) 12 can be electronic devices that do not allow for placing and/or receiving telephone calls, but do allow, however, for downloading data (e.g., email and/or applications) over a conventional cellular telephone network or the like. Further, the cellular device(s) 12 each have their own display 11.

In an embodiment, cellular device(s) 12 includes conventional hardware and software for linking to the wireless access point 16 via communication link 14. Preferably, but not necessarily, cellular device(s) 12 includes a keyboard or an other conventional input device (e.g. touchscreen, microphone, motion sensor) for receiving input or commands from a user (not shown).

The software for linking the cellular device(s) 12 to the wireless access point 16 is an application that is downloaded from the router/server 18 or internet 22. The application will display the available router/server(s) 18 on the display of the cellular device 11. In public settings, where more than one router/server 18 is available, the application will allow user(s) to choose which router/server 18 to interact with. Preferably, but not necessarily, the application only needs to be downloaded once for each cellular device.

The wireless access point 16 is a conventional electronic device for receiving and transmitting signals to the cellular device(s) 12 via bi-directional communication link(s) 14. The wireless access point 16 is coupled to the router/server 18 via a conventional cable or bus. Accordingly, wireless access point 16 relays command and/or control signals between cellular device(s) 12 and the router/server 18. In addition, the wireless access point 16 can be integrally included within the router/server 18, instead of being a separate standalone unit or device.

The router/server 18 provides, at least in part, for conventional interactive computing whereby video/audio signals are produced for use with output devices 20 comprising a television, monitor, view screen, speakers, or the like. In an embodiment, the router/server 18 can be a specific machine designed for playing video games, or a personal computer, or a router that is operatively connected to the Internet 22. Moreover, the router/server 18 can include memory (not shown) for storing data.

The router/server 18 can also interact with servers 24 to provide a bigger interactive experience amongst more players and/or to obtain information that may be better stored on larger servers 24. In this embodiment, but not necessarily, the input commands from cellular device 12 are bi-directionally transmitted via the access point 16, and the router/server 18, to and from the remote server(s) 24.

Loaded onto the router/server 18 or server(s) 24, wherein the server(s) 24 are accessible via server/router 18, is the software/application that processes the data received from cellular device(s) 12. The router/server 18 uses the processed data to interact or manipulate objects on display 20 and returns data to the cellular device(s) 12 for more input. Stated another way, the application allows, in part, a user to play a video game by using a cellular device 12 as a game controller. In particular, a user can enter commands to the router/server 18 or server(s) 24 by using the keyboard, touchscreen, or other input method of the cellular device 12. The router/server 18 will have administrator options in the software to allow an administrator control over the system 10.

Data can also be downloaded and maintained on the memory of the cellular device(s) 12. This data can include, for example, game images that are constantly used, personal data, or obtained high scores and rankings associated with various video games. Accordingly, players can compare their respective scores and ranking to other players at various locations.

The portion of the system 10 comprising the display 20 and wireless access point 16 and router/server can be provided in various commercial or private settings. For instance, the system 10 can be provided in homes, classrooms, restaurants, bars, waiting rooms and stadiums. Moreover, on a secure system, off-track betting and casino games could be accommodated.

As will be appreciated by those having ordinary skill in the art, the system 10 allows anyone with a cellular device 12 to connect and play a video game via the router/server 18, which may be connected to server(s) 24. These games and/or applications can be directed to leisure, entertainment, educational, or any combination thereof

In an embodiment, many of the games are exclusive to this system and method 10 because cellular devices 12 have their own displays 11. Personal information, with regard to the video games or applications in use, is displayed on the display screen 11 of individual cellular devices 12 while the main display 20 hosts or displays public information or the game layout. For instance, in a video poker game of Texas Hold'em, the main display 20 presents the flop, pot, and whose action it is while each individual's cellular device 12 would display 11 the private information associated with the user such as, in this case, the hole cards.

The present invention also allows board games to be played without setup and finding lost pieces. Moreover, trivia games will not get old since new questions can be downloaded. New forms of trivia games can be invented incorporating use of the private display 11 on the cellular device(s) 12 and the community display 20. Further, individuals can compete against each other in puzzle games that were not possible before. Surveys or votes can be taken from many people quickly and easily. Bars can host games where sports fans compete against each other for prizes while watching their favorite teams.

In yet another embodiment, the present invention can be applied to a queue such as, for example, when one or more persons are waiting for reservations at a restaurant or other services. In this embodiment, users wirelessly connect their cellular device(s) 12 to the router/server 18 and are assigned a queue number or time by the router/server 18 and/or an administrator (not shown) operating the server. The user is then notified when he or she is selected (i.e., is at the front of the queue) by the router/server 18 sending a notification to the user's cellular device 12 that is shown on its display 11. While patrons wait to be seated they can play along with others at the restaurant.

Commercial advertising can also be an integral part of the system. For instance, if the video same is provided free, such as in a public setting (e.g., a stadium), then sponsors can place advertisements for their products on the display screen 20, a portion of the display screen 20, and/or on the individual displays 11 of the cellular devices 12.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention, and protected by the following claims.

I claim:

1. A method for allowing interactivity between users comprising:
one or more servers and software for receiving, processing and sending application content to the users and/or between other servers,
at least one wireless access point for communicating with cellular devices and the server,
a connection between the one or more wireless access points and the server(s) through routers and across the Internet,
cellular device applications that send and receive private data to the server, and
output device(s) connected to the server(s) that output public data to all users within a physical location.

2. The method of claim 1, wherein private data is displayed through a cellular device to each user.

3. The method of claim 1, wherein the server, router, wireless access point and software are either distributed or incorporated into a single component or group of components.

4. An entertainment system using cellular devices as an auxiliary means of input/output.
